(19) United States
(12) Patent Application Publication
(10) Pub. No.: US 2005/0058375 A1
(43) Pub. Date: Mar. 17, 2005

(54) Bushing structure

(75) Inventor: Hai-Tao Ma, Wu Chung City (CN)

Correspondence Address: Ladas & Parry, 26 West 61st Street, New York, NY, 10023, US

(73) Assignee: BENQ CORPORATION

(21) Appl. No.: 10/942,687

(22) Filed: Sep. 16, 2004

(30) Foreign Application Priority Data
Sep. 16, 2003 (TW) 92125493

(51) Int. Cl. F16C 33/02; F16D 51/00

(52) U.S. Cl. 384/276

(57) ABSTRACT

A bushing structure includes an outer shell and an inner shell. The outer shell shaped as a thin ring with a predetermined length further has at least a locating aperture. The inner shell shaped as another thin ring to be double layered firmly inside the outer shell has at least a locating protrusion with respect to the locating aperture. When the inner shell is mounted inside the outer shell, the locating protrusion is anchored inside the respective locating aperture so as to prevent possible relative movement in between. By providing the thin outer shell and the thin inner shell to form a complete bushing structure, an inherent material-shrinkage problem of plastic bushing can then be avoided.

### BACKGROUND OF THE INVENTION

(1) Field of the Invention

The invention relates to a bushing structure, and more particularly to a two-piece bushing which includes a hard body and a separable soft lining for absorbing possible deformation formed during the application of the bushing.

(2) Description of the Prior Art

Bushings or bearings in the art are usually utilized on shafts or shaft-like elements for providing lubrication, offset or wear compensation. Generally speaking, in the case that the bushings are designed for lubricating shafts, ductile materials such as coppers are usually used. On the other hand, in the case that the bushings are used as compensations for offsets and wears, material selection can be more versatile. However, in consideration of material cost and its performance, it is obvious that the plastic material become much and much popular in making the bushings.

While the plastic material is used to replace the metals for producing the bushings, two of obvious advantages are cost down and ease in manufacturing. On the other hand, disadvantages of utilizing the plastics may include less-precision control, ill environmental resistance, and short service life. The latter two can be acceptable trade-offs with respect to the low-cost merit. Yet, the problem in less-precision control while in producing the plastic bushings is really concerned and is a topic to be overcome.

It is well known that the dimension distortion in production is an inherent feature to the plastic material. In the art, plastic bushings are generally produced by inject-molding which usually present a shrinkage problem in the plastic products. Empirically, the shrinkage problem is highly related to the thickness of the product. In the case that a bushing is thick, a high degree of shrinkage is usually seen. On the other hand, in the case that a bushing is thin, the shrinkage problem would be dim and usually show no harm to the operation of the bushing.

Referring to FIG. 1, a cross-sectional view of a traditional plastic bushing 3 applied to carry a shaft 2 on a work piece 1 is shown. The bushing 3 firstly sleeves the shaft 2 and then the combination is mounted to a hole of the work piece 1. Ideally, by providing the bushing 3 to interface rotations of the shaft 2 on the work piece 1, better lubrication can be achieved and also possible dimension bias in between can be compensated.

Nevertheless, if a shrinkage cavity 30 as shown in FIG. 1 exists whatever in the bushing 3, a severe eccentric rotation would happen to the combination of the shaft 2 and the bushing 3. As a consequence, notorious vibrations or some other ill-rotation problems would occur and severely may even degrade dynamic performance of the combination which has a high possibility to make worse the wears of the bushing 3.

Therefore, an improvement upon the plastic bushing structure for overcoming foregoing shrinkage problem so as to avoid unexpected consequence in rotating a biased shaft is definite a topic to the art.

### SUMMARY OF THE INVENTION

Accordingly, it is a primary object of the present invention to provide a two-piece bushing structure which has less shrinkage in production by separately forming a sleeve body and a lining element.

The bushing structure of the present invention includes a sleeve body and a lining element to be mounted firmly inside the sleeve body. The sleeve body, formed as a cylindrical shell, has a first end and an opposing second end. The first end can further include at least a locating aperture. The lining element, formed as another cylindrical shell to be fixedly telescoped inside the sleeve body, has a first lining end and an opposing second lining end. The first lining end can further include at least a locating anchor. While the bushing structure of the present invention in an assembly state, the lining element fits inside the sleeve body with the first lining end adjacent to the first end, the second lining end adjacent to the second end, and the locating anchor nesting in the respective locating aperture so as to form a stop pair for preventing relative motion between the sleeve body and the lining element.

In one embodiment of the present invention, the lining element can further include at least an elastic arm formed as a cantilever beam extended to the first lining end by cutting axially the lining element. In this embodiment, the locating anchor to pair with the locating aperture of the sleeve body can be now located at a free end of the elastic arm. Preferably, the locating anchor can further include an out-facing lead surface for facilitating assembling of the lining element into the sleeve body.

In one embodiment of the present invention, the second end of the sleeve body can further include at least a positioning part, while the second lining end includes at least a positioning counter part. While the bushing structure in the assembly state, the positioning part can match with the respective positioning counter part so as to form another stop pair for preventing relative motion between the sleeve body and the lining element.

In this embodiment, the positioning part can be formed as a protrusion while the positioning counter part is formed as an aperture for receiving the protrusion.

Alternative, in this embodiment, the counter positioning part can be formed as a protrusion while the positioning part is formed as an aperture for receiving the protrusion.

In one embodiment of the present invention, the second lining end of the lining element can further include a flange. While the bushing structure in the assembly state, the flange is located exterior to the second end so as to form another stop pair for preventing relative motion between the sleeve body and the lining element.

In the embodiment including the flange, the second end of the sleeve body can further include at least a positioning part while the flange includes at least a positioning counter part for matching with the respective positioning part so as to form a further stop pair for preventing relative motion between the sleeve body and the lining element. Similarly, in this embodiment, the positioning part can be formed as a protrusion while the positioning counter part is formed as an aperture for receiving the protrusion. Also, alternative, in this embodiment, the counter positioning part can be formed as a protrusion while the positioning part is formed as an aperture for receiving the protrusion.

In the present invention, the sleeve body is preferably made of a material harder than that for making the lining element, such that the lining element can be easily mounted into the sleeve body.

All these objects are achieved by the bushing structure described below.

### BRIEF DESCRIPTION OF THE DRAWINGS

The present invention will now be specified with reference to its preferred embodiment illustrated in the drawings, in which

FIG. 1 is a cross-sectional view of a conventional plastic bushing used in mounting a shaft into a work piece;

FIG. 2 is a perspective exploded view of a first embodiment of the bushing structure in accordance with the present invention;

FIG. 3 is a cross-sectional view of the bushing structure of FIG. 2 used in mounting a shaft into a work piece;

FIG. 4 is a perspective view of a preferred lining element of a second embodiment of the bushing structure in accordance with the present invention;

FIG. 5 is a cross-sectional view of a third embodiment of the bushing structure in accordance with the present invention;

FIG. 6 is a perspective exploded view of a fourth embodiment of the bushing structure in accordance with the present invention; and

FIG. 7 is a perspective exploded view of a fifth embodiment of the bushing structure in accordance with the present invention.

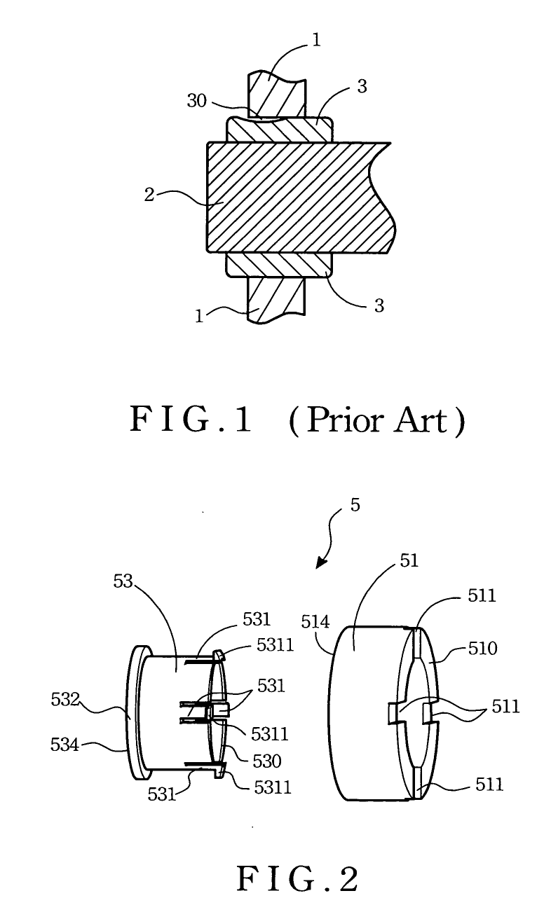

### DESCRIPTION OF THE PREFERRED EMBODIMENT

The invention disclosed herein is directed to a bushing structure. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the following description, those components having the same function but different profiles or locations are named and labeled by the same so as to achieve consistency in presenting the present invention.

In order to resolve the aforesaid shrinkage problem of the plastic bushings, it is noted that producing the cylindrical bushing with a relative thin wall is obvious a resort. Based on this understanding, the present invention presents a two-piece bushing structure to give the designer a better control upon the thickness selection of each single piece.

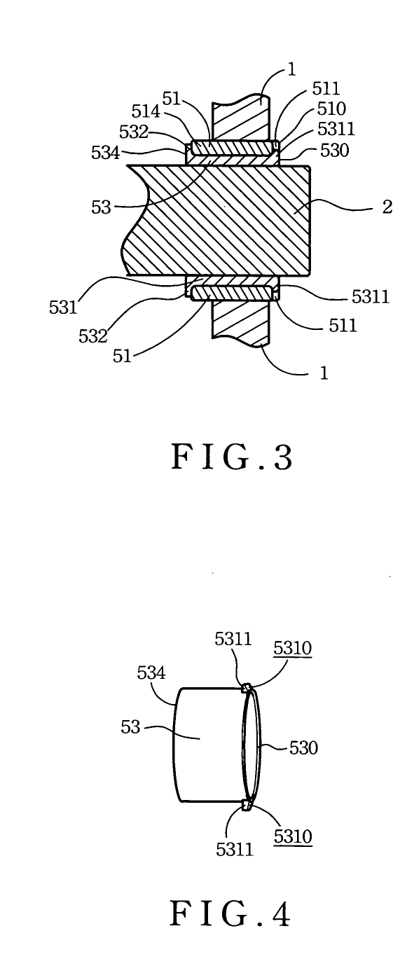

Referring now to FIG. 2 and FIG. 3, a perspective exploded view of a first embodiment of the bushing structure in accordance with present invention and a cross-sectional view of the first embodiment in application are shown, respectively. In the first embodiment, the bushing structure 5 can include a sleeve body 51 and a lining element 53 to be mounted firmly inside the sleeve body 51.

The sleeve body 51, preferably formed as a cylindrical shell, has a first end 510 and an opposing second end 514. The first end 510 can further include at least a locating aperture 511 (four shown in this embodiment).

The lining element 53, shaped as another cylindrical shell to be fixedly telescoped inside the sleeve body 51 so as to form the bushing structure 5 as a double-eccentric-layer shell structure, has a first lining end 530 and an opposing second lining end 534. The first lining end 530 can further include at least a locating anchor 5311 (four shown in this embodiment). The second lining end 534 can further include a flange 532. As shown, the lining element 53 can further include at least an elastic arm 531 (four shown in this embodiment) formed as a cantilever beam extended to the first lining end 530 by cutting axially the lining element 53.

In this embodiment, the locating anchor 5311 to pair with the locating aperture 511 of the sleeve body 51 can be located at a free end of the elastic arm 531. By providing elasticity of the cantilever-shape elastic arms 531, the locating anchor 5311 can be easily pushed inward radially during the lining element 53 telescoping or plugging into the sleeve body 51.

As shown in FIG. 2, the locating anchor 5311 can further include an out-facing lead surface 5310 for easing the elastic arm 531 to deflect while encountering the pushing of the sleeve body 51 during the assembling and thus for facilitating assembling of the lining element 53 into the sleeve body 51.

Also, in this embodiment, the flange 532 is formed as a collar at the second lining end 534 of the lining element 53. While the lining element 53 is mounted inside to the sleeve body 51, the flange 532 can act as a position stop for the second end 514 of the sleeve body.

As shown in FIG. 3, while the bushing structure 5 of the present invention in an assembly state, the lining element 53 just fits inside the sleeve body 51 with the first lining end 530 adjacent to the first end 510, the second lining end 534 adjacent to the second end 514, and the locating anchor 5311 nesting in the respective locating aperture 511 so as to form the bushing structure 5 as a double-layer shell. In this embodiment, the pair of the locating anchor 5311 and the locating aperture 511 forms a stop pair to prevent relative motion between the sleeve body 51 and the lining element 53, while the pair of the flange 532 of the second lining end 534 and the second end 514 forms another stop. Since the two-piece structure 5 is formed, the bushing structure 5 can be sleeved onto a shaft 2, and then the combination of the shaft 2 and the bushing structure 5 can be mounted into a hole or a bore of a work piece 1.

In the present invention, the sleeve body 51 is preferably made of a material harder than that for making the lining element 53. Upon such an arrangement, the soft lining element 53 can be easily mounted into the sleeve body 51 and can have a better contribution in compensating possible offset or wear of the shaft 2. On the other hand, the harder sleeve body 51 can achieve a better shield effect so as to steadily rotate in or engage with the work piece 1. Also, the rotation center of the shaft 2 can be thus effectively ensured by the hard sleeve body 51.

In the first embodiment, the lining element 53 can be easily assembled inside to the sleeve body 31 with the help from the elastic arms 531 which can deflect inward radially to allow the sleeve body 51 to pass the locating anchor 5311 easily during the assembling. Also, the flange 532 of the lining element 53 can perform as an end stop for the sleeve body 51 while in assembling.

Nevertheless, inclusions of the elastic arms 531 and the flange 532 are not requirements in the present invention. The reason is that both the sleeve body 51 and the lining element 53 are made of plastics which present substantial elasticity. Under proper managements of dimensions and materials for the sleeve body 51 and the lining element 53, the assembling of the busing structure of the present invention would not cause any problem. In particular, in the case that the lining element 53 is made of a softer material, the elastic arms 532 of the lining element 53 can be retractable. Similarly, with substantial engagement between the locating aperture 511 and the locating anchor 5311, the flange 532 can be omitted.

Referring now to FIG. 4, a lining element 53 of a second embodiment of the bushing structure in accordance with the present invention is perspective shown. In this embodiment, the bushing structure can include the sleeve body 51 shown in FIG. 2 and the lining element 53 shown in FIG. 4. The lining element 53 of FIG. 4 obviously cancel the design of the flange and the elastic arms as described in the first embodiment. As stated, such cancellation wouldn't affect the engagement of the sleeve body 51 and the lining element 53.

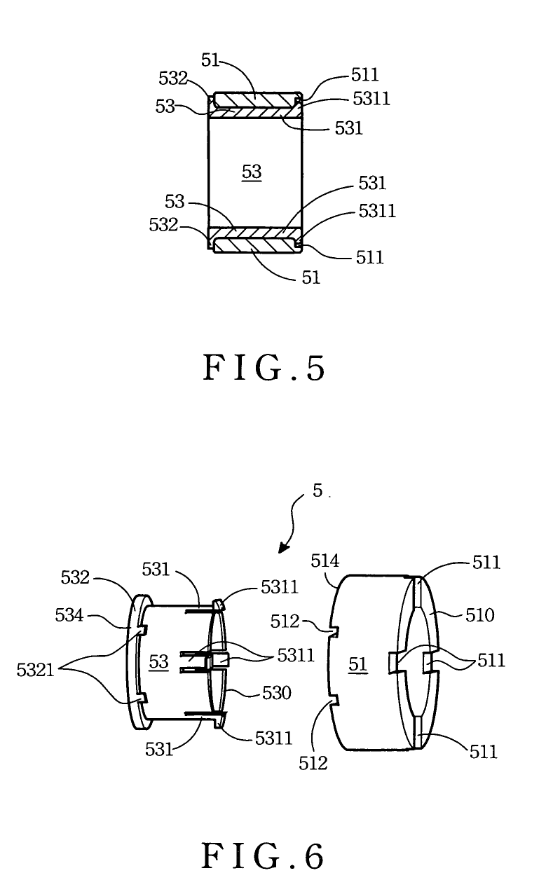

Referring now to FIG. 5, a cross-sectional view a third embodiment of the bushing structure in accordance with the present invention is shown. Compared with the foregoing first embodiment of FIG. 3, this third embodiment adopts the lining element 53 as the same as the first embodiment does. On the other hand, a difference in sleeve body 51 exists in the structure of the locating aperture 511. In the first embodiment as shown in FIG. 2 or FIG. 3, the locating aperture 511 is open through the exterior surface of the sleeve body 51. Contrarily, in this third embodiment of FIG. 5, the locating aperture 511 is a blind aperture with respect to the exterior surface of the sleeve body 51.

Referring now to FIG. 6, an exploded perspective view of a fourth embodiment of the bushing structure in accordance with the present invention is shown. Compared with the first embodiment of FIG. 2, the second end 513 of the sleeve body 51 of this fourth embodiment can further include at least a positioning part 512 (shown as an aperture), while the second lining end 534 of the lining element 53 includes at least a positioning counter part 5321 (shown as a protrusion of the flange 532 toward the first lining end 530. While the bushing structure 5 in the assembly state, the positioning part 512 can match with the respective positioning counter part 5321 so as to form another stop pair for preventing relative motion, mainly distortion, between the sleeve body 51 and the lining element 53.

In FIG. 6, the pair of the positioning part 512 and the positioning counter part 5321 is embodied as a pair of an aperture and a counter protrusion on the flange 532, respectively. Yet, in the present invention, the protrusion as the positioning counter part 5321 needn't co-exist with the flange 532. In an embodiment not shown here, the lining element 53 can exclude the flange 532 but include the protrusion type of the positioning counter part 5321.

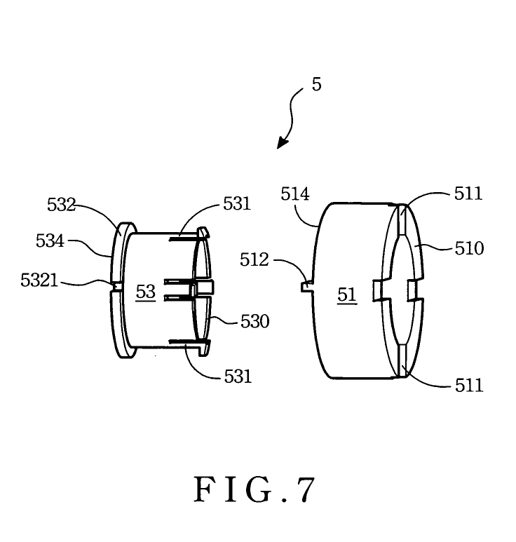

Referring now to FIG. 7, a perspective exploded view of a fifth embodiment of the bushing structure in accordance with the present invention is shown. Compared with the foregoing fourth embodiment of FIG. 6, the positioning part 512 of the sleeve body 51 in the fifth embodiment is embodied as a protrusion while the positioning counter part 5321 of the lining element 53 is embodied as a counter aperture formed in the flange 531. While the fifth embodiment 5 is in the assembly state, the protrusion 512 of the sleeve body 51 can engage with the counter aperture 5321 of the lining element 53 so as to define a predetermined stop or engagement relation for avoiding further motions between the lining element 53 and the sleeve body 51.

By providing the two-piece bushing structure of the present invention, the prior shrinkage problem in producing the conventional one-piece bushing can be avoided and also a better control on applying the bushing can be achieved.

While the present invention has been particularly shown and described with reference to a preferred embodiment, it will be understood by those skilled in the art that various changes in form and detail may be without departing from the spirit and scope of the present invention.

1. A bushing structure, comprising:
a sleeve body, formed as a cylindrical shell, having a first end and an opposing second end, the first end further including at least a locating aperture; and
a lining element, formed as another cylindrical shell to be fixedly telescoped inside the sleeve body, having a first lining end and an opposing second lining end, the first lining end further including at least a locating anchor;
wherein, in an assembly state, the lining element fits inside the sleeve body with the first lining end adjacent to the first end, the second lining end adjacent to the second end, and the locating anchor nesting in the respective locating aperture as a stop pair to prevent relative motion between the sleeve body and the lining element.

2. The bushing structure according to claim 1, wherein said lining element further includes at least an elastic arm formed as a cantilever beam extended to said first lining end by cutting said lining element, and said locating anchor is now located at a free end of the elastic arm.

3. The bushing structure according to claim 1, wherein said second end further includes at least a positioning part, wherein said second lining end further includes at least a positioning counter part; while in said assembly state, the positioning part matching with the respective positioning counter part for forming another stop pair to prevent relative motion between said sleeve body and said lining element.

4. The bushing structure according to claim 3, wherein said positioning part is formed as a protrusion and said positioning counter part is formed as an aperture for receiving the protrusion.

5. The bushing structure according to claim 3, wherein said counter positioning part is formed as a protrusion and said positioning part is formed as an aperture for receiving the protrusion.

6. The bushing structure according to claim 1, wherein said second lining end further includes a flange; while in said assembly state, the flange locating exterior to said second end and forming another stop pair to prevent relative motion between said sleeve body and said lining element.

7. The bushing structure according to claim 6, wherein said second end further includes at least a positioning part, wherein said flange further includes at least a positioning counter part; while in said assembly state, the positioning part matching with the respective positioning counter part for forming a further stop pair to prevent relative motion between said sleeve body and said lining element.

8. The bushing structure according to claim 7, wherein said positioning part is formed as a protrusion and said positioning counter part is formed as an aperture for receiving the protrusion.

9. The bushing structure according to claim 7, wherein said counter positioning part is formed as a protrusion and said positioning part is formed as an aperture for receiving the protrusion.

10. The bushing structure according to claim 1, wherein said locating anchor further includes an out-facing lead surface for facilitating assembling of said lining element into said sleeve body.

11. The bushing structure according to claim 1, wherein said sleeve body is made of a material harder than that for making said lining element.
